(19) United States
(12) Patent Application Publication
(10) Pub. No.: US 2007/0016460 A1
(43) Pub. Date: Jan. 18, 2007

(54) Task management system having selectively variable check data

(75) Inventor: Martin M. Weiss, Cranberry Township, PA (US)

Correspondence Address: WOOD, HERRON & EVANS, LLP, 2700 CAREW TOWER, 441 VINE STREET, CINCINNATI, OH, 45202, US

(73) Assignee: Vocollect, Inc.

(21) Appl. No.: 11/181,105

(22) Filed: Jul. 14, 2005

(51) Int. Cl. G06F 9/46

(52) U.S. Cl. 705/8

(57) ABSTRACT

A wireless task management system allows a user to communicate check data read or perceived from selectively variable for confirmation. A control unit controls the display, which selectively varies and displays the check data for the user. The check data is generally reflective of an object or location associated with an assigned task.

### TECHNICAL FIELD

The present invention is directed to systems for handling and confirming the completion of multiple tasks by a user or worker, and more particularly, to systems having displayed check data information configured to be entered or spoken by a user to confirm completion of an assigned task, e.g., arrival by the user at a designated location associated with the check data.

### BACKGROUND ART

Speech recognition has simplified many tasks in the workplace by permitting hands-free communication with a computer as a convenient alternative to communication via conventional peripheral input/output devices. A user may enter data by voice using a speech recognizer and commands or instructions may be communicated to the user by a speech synthesizer. Speech recognition finds particular application in mobile computing devices in which interaction with the computer by conventional peripheral input/output devices is restricted.

For example, wireless wearable terminals can provide a user performing work-related tasks with desirable computing and data-processing functions while offering the user enhanced mobility within the workplace. One particular area in which users rely heavily on such wireless wearable terminals is inventory management. Inventory-driven industries rely on computerized inventory management systems for performing various diverse tasks, such as food and retail product distribution, manufacturing and quality control. An overall integrated management system involves a combination of a central computer system for tracking and management, and the people who use and interface with the computer system in the form of order fillers and other users. In one scenario, the users handle the manual aspects of the integrated management system under the command and control of information transmitted from the central computer system to the wireless wearable terminal.

As the users process their orders and complete their assigned tasks, a bi-directional communication stream of information is exchanged over a wireless network between the users wearing wireless terminals and the central computer system that is directing multiple users and verifying completion of their tasks. Information received by each wearable terminal from the central computer system is translated into voice instructions or text commands for the corresponding user. Typically, the user wears a headset coupled with the wearable device. The headset includes a microphone for voice data entry and an ear speaker for audio output feedback. Responses from the user are input into the wireless wearable terminal by the headset microphone and communicated from the wearable terminal to the central computer system. Similarly, instructions from the central computer are delivered to the user via the headset speaker. Using such wearable terminals, users may perform assigned tasks virtually hands-free without equipment to juggle or paperwork to carry around. Because manual data entry is eliminated or reduced, users can perform their tasks more accurately and efficiently.

An illustrative example of a set of user tasks suitable for a wireless wearable terminal with voice capabilities may involve initially welcoming the user to the computerized inventory management system and defining a particular task or order, for example, filling a load for a particular truck scheduled to depart from a warehouse. The user may then answer with a particular area (e.g., freezer) that they will be working in for that order. The system then vocally directs the user to particular aisles and bins to pick particular quantities of various items. The user vocally confirms each location and the number of picked items. For instance, the user reads a label located on a bin. The label has one or more “check digits” printed on it that are associated with the product and/or bin. The user then speaks or otherwise enters the check digits into the wearable terminal.

The check digits function, in part, to confirm that the user is located at the correct bin for the items to be picked. That is, the central system receives a signal conveying the check digits spoken or entered by the user, and verifies that the spoken digits are correct for that order or pick task. The system may send an alert to the user if the spoken or entered check digits do not match stored check data correlated to the bin/slot. In this manner, the chances of the user being at the wrong slot and/or picking an unspecified or undesired product are greatly reduced. After the location is confirmed and the pick made, the system may then direct the user to a loading dock or bay for a particular truck to receive the order. As may be appreciated, the specific communications exchanged between the wireless wearable terminal and the central computer system are generally task specific.

Despite the efficiencies and accuracy afforded by wireless wearable terminals and the common use of check digits and labels, problems in inventory retrieval and management persist. In one example, users become familiar with check digits and associated slot locations. The potential therefore exists for a user to recall from memory and audibly speak the check digits associated with a slot location without actually being at the designated slot location, e.g., when approaching a bin aisle or noting tasks in a break room. By circumventing the requirement of actually reading the check digits at the bin, the user may thus undermine the safeguards that would otherwise ensure that the proper items are located. Namely, the user can enter the correct digits while retrieving the wrong item.

Accordingly, there is still an unmet need to ensure accuracy in task completion, such as tasks involving order picking using check data. There is further a need to force users to physically observe or be proximate to check data to verify order picking while discouraging mental recall of check data. Furthermore, it is desirable to increase awareness and feedback to the system, allowing the central management system to further gain accuracy counts. These issues and other needs in the prior art are met by the invention as described and claimed below.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 illustrates an exemplary environment in which wireless devices operate in accordance with the principles of the present invention.

FIG. 2 is a flowchart of an exemplary method of updating check data using program code executed by the system of FIG. 1 in accordance with the principles of the present invention.

FIG. 3 is a block diagram of an embodiment of an electronic display of FIG. 1 in accordance with the principles of the present invention.

FIG. 3A is a block diagram of an alternative embodiment of an electronic display in accordance with the principles of the present invention.

FIG. 4 is a block diagram of a central computer of FIG. 1 in accordance with the principles of the present invention.

### DETAILED DESCRIPTION OF SPECIFIC EMBODIMENTS

Embodiments of the present invention generally relate to a task management system that requires a user to speak or otherwise enter into a system check data that is read or obtained from a selectively variable display for confirmation of an assigned task. The displayed check data is selectively varied and tracked, such as by a central computer system for comparison against subsequently spoken or electronically read check data associated with assigned tasks of a user. To that end, the central system may be varied periodically, such as on a daily, weekly, or monthly basis. Alternatively, this display might be selectively varied more frequently, such as hourly, or in response to an event, such as a successful pick or completion of a shift for one or more users. The selectively variable display, in accordance with the principles of the invention, may utilize various different technologies for providing the variable check data.

In one embodiment of the invention, the selectively variable display is utilized in an inventory management scenario. For example, a central system transmits a task message or task instructions to selected terminal assigned to multiple users. At the terminal, the message is typically converted to a perceptible form for the user, such as an audio speech signal that is output via a headset speaker. Alternatively, the central computer may send a text message to one or more of the terminals. In response to the directions of the central system, a user executes a task, which may involve travel to a location or slot designated in the task message. At the location, the user may speak into their terminal headset the check data they have read from the selectively variable display associated with the location or item. In another embodiment, the check data may be electronically read or otherwise input into the terminal by the user. For purposes of illustrating one embodiment of the invention, a voice directed system is described herein, however, other forms of communication between the central computer and a user might be utilized, such as text messaging or electronic and optical scanning.

The central computer confirms the accuracy of the input check data to ensure that the user is in the proper location and has successfully completed the assigned task. Since the check data presented on the display may be selectively varied, e.g., periodically, in response to an event or randomly, the user is effectively prevented from memorizing the data in any consistent fashion, thus adding to the overall accuracy of the system. This reduces or prevents the occasions where the check data is memorized for particular tasks or locations or otherwise becomes overly familiar to a user. The central computer may then selectively vary the check data on a regular basis for comparison against future assigned tasks.

As noted above, one typical use of the invention may include inventory management or quality control applications running as part of an overall inventory management or manufacturing program. In accordance with an aspect of the invention, users are made to diligently execute their tasks, such as go to an instructed location and observe displays and associated new check data, increasing overall awareness and accuracy in the system. The automatic and selective variation and alteration of check data enables easy updates of the displays with relatively little additional infrastructure support. Moreover, users may continue to provide hands-free verification. In one embodiment, the electronic display may be bistable, or configured to present and maintain the check data in the absence of continuous power.

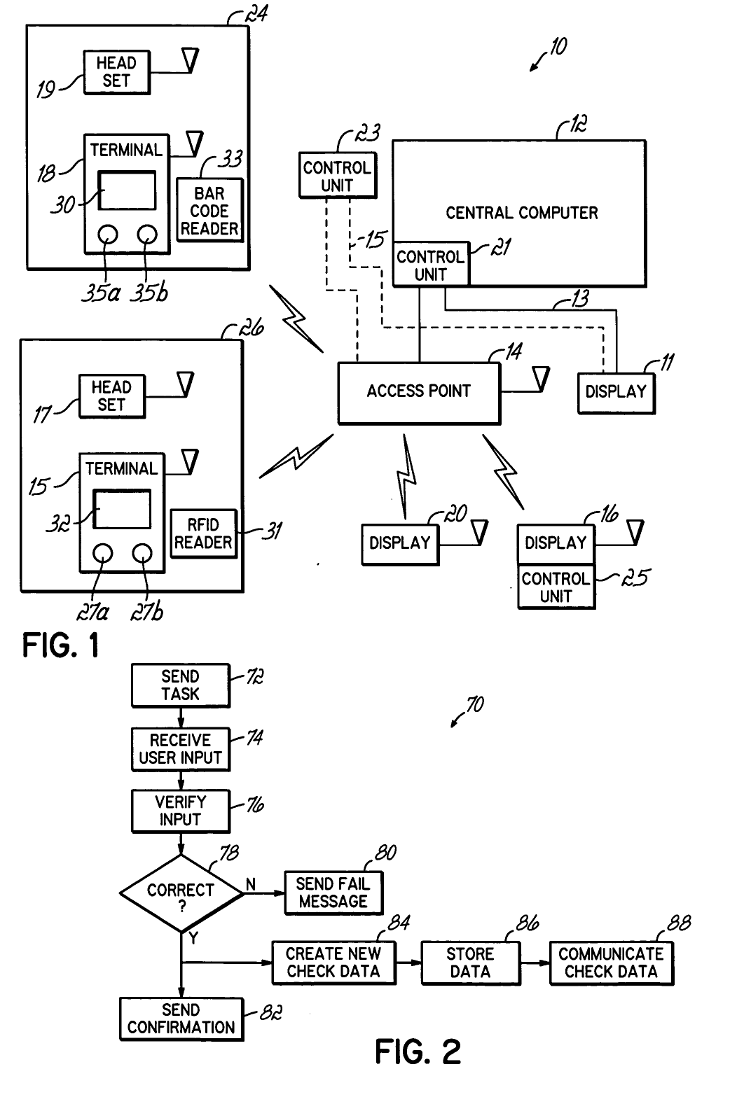

FIG. 1 illustrates an exemplary system 10 wherein the invention might be implemented. In system 10, one or more terminals 15, 18 communicate with a central computer 12. The central computer 12 is able to send messages to portable terminals 15, 18. The portable terminals 15, 18, which may be wearable by a user, have associated headsets 17, 19. Herein, the terminal/headset pairs are collectively referred to by reference numerals 24, 26. The terminals 15, 18 may communicate the task to the user via voice using the associated headset 17, 19. Alternatively, visual displays 30, 32 of the terminals may be used to display a text message.

For example, through multiple instructions, the user may be directed to perform a task that requires the user to travel to the location designated in the task to pick a product. Once at the designated location, such as a product slot I a warehouse, the user can read or otherwise determine the check data associated with the slot or product at the slot on a display 11, 16, 20 that is located proximate to the slot. The displays operate in accordance with the principles of the invention as discussed in greater detail below. The displays are preferably electronic displays and can be selectively varied from a central locator. While three displays are shown, obviously a greater or lesser number might be utilized. Once the check data is obtained by a user at the slot, it is communicated to the central system for typical verification that it is correct, and that the user is at the proper location, or is handling the proper items for the task. Check data may be visually or optically displayed to be visually read by a user or might be electronically displayed to be read by equipment such as bar code readers and RFID readers. Therefore, the term “displayed” as used herein refers generally to the check data being available at a location or on a product to be perceived or read by a user and equipment. It is not limited to visual displays only.

Before discussing further details of the displays 11, 16, 20 of the inventive system, other features provide context to the overall system. Referring again to FIG. 1, the links between the terminals 24, 26 and the central computer 12 are typically wireless (e.g. 900 MHz, 2.4 GHz, Blue Tooth networks, etc.), which allows multiple terminals to share the spectrum and allows communication with mobile users. The links between the terminal hardware 15, 18 and the respective headsets 17, 19 are typically a cable or wire. In alternative embodiments, the headsets and terminals may be coupled together via a wireless connection. The displays 16, 20 of FIG. 1 are in wireless communication with the central computer 12, while another display 11 may be hardwired 13 to the central computer 12 or other control unit 23.

Therefore, various means might be utilized to control the multiple displays for selectively varying the data displayed by those displays. One of ordinary skill will recognize that a number of wireless network technologies are currently available for implementation as part of the present invention.

In the exemplary environment 10 of FIG. 1, the central computer 12 is coupled with one or more access points 14 that are distributed throughout an area serviced by a wireless network. One or more control units 21, 23 are configured to communicate with a display to selective vary the check data of the display. As shown in FIG. 1, an exemplary control unit 21 may comprise part of the central computer 12. Control unit 21 may control the displays 16, 20 with a wireless connection through access point 14 or a wired connection 13. A control unit 23 may also be remote from the central computer and may use a wireless connection 14 or a wired connection 15. In this manner, an electronic display may be selectively controlled by the central computer or some other control unit. The control units are operable to selectively vary a single display, a group of displays, or all displays coupled to the particular control unit as desired by a system or facility manager.

In another embodiment, the control unit 25 might be co-located with one or more displays, such as display 16 as shown. In that way, a display might be individually varied. For example, tasks involving certain slots or products might have an inordinate amount of inaccuracies associated therewith, and therefore, it may be desirable to let a floor manager or facility manager, just randomly vary the check data of the display 16 without varying the check data of other displays. Also, various combinations of control units 21, 23, 25 might be utilized in a facility as desired to tailor a specific check data variation scheme according to the invention.

Each user within the environment of FIG. 1 uses a terminal 15, 18 and an associated headset 17, 19. As noted, terminal hardware 15, 18 may include a visual display 30, 32 for displaying text messages. One or more indicator lights 27a, 27b, 35a, 35b that may be illuminated based on messages received by the terminals 15,18, or awaiting action. While only two terminals 24, 26 are shown in this figure, fewer or more users may be accommodated within the system 10. Exemplary headsets are marketed by the present Assignee as SR-20 Talkman® Lightweight Headset and exemplary terminals are marketed by the present Assignee Talkman® T2. Other headsets and terminals having similar capabilities are contemplated within the scope of the present invention as well.

Users utilize the terminals 15, 18 and headsets 17, 19 to obtain tasks and to communicate check data obtained from electronic displays 11, 16 and 20 to verify proper completion of the task. While in a primary exemplary environment, the workers read the check data, and then speak the check data into the headsets 17, 19, or type the data into the terminal, the displayed check data, in another embodiment may be read in other ways. For example, the displayed check data might be scanned or automatically read. For instance, suitable reading devices may include radio frequency identification (RFID) readers 31, or bar code readers 33. The displays, for example, may display bar codes or other graphics that may be read. Alternatively, machine-readable information may reside on an RFID microchip associated with the display to be read or perceived by an RFID reader. An RFID microchip transmits the RFID user input over a radio frequency readable by a RFID reader 31. The RFID 31 or bar code reader 33 may be part of the terminals 24, 26 or may be separate units but coupled to the terminals.

Generally, once visually read, the check data information must be entered into the terminal hardware 16, 18, to be communicated to the central system. This can be done with voice through the headsets, or may be typed or otherwise entered in the terminal hardware. To that end, the terminals may include appropriate capabilities, such as a keyboard (not shown). When the check data is electronically read, such as by a reader 31, 33, it is directed in electronic form to the terminal hardware.

In accordance with one aspect of the invention, the RFID or bar code/graphic components of a display are rewriteable or changeable for dynamically and selectively updating the check data information displayed thereon.

FIG. 2 is a flowchart 70 illustrating a series of steps executable in one exemplary check data scenario. More particularly, the steps of the flowchart 70 are directed to leading a user through a task associated with check data and selectively varying, or altering, the check data used to verify a stage of the task's completion. At block 72, the central computer 12 may generate and send instructions or a task to a terminal 18 worn by a worker or other user. For example, the central computer may direct a user to pick an item and the worker may in response travel to an appropriate bin, slot, or other location. At the slot, the user views, reads or otherwise perceives the check data presented by the electronic display 16 proximate the slot. For instance, in one common application, the user may read an alphanumeric code or check digit(s) comprising the check data that is visually displayed. That check data is then entered into the terminal 24, such as by being spoken into a microphone of the headset 19. The central computer 12 receives this audible input in the form of user input at block 74 of FIG. 2.

The central computer 12 then verifies the accuracy of the check data at block 76. For instance, the central computer 12 may recall stored check data associated with the slot, item and/or display 16. The verification includes comparing the stored check data to the check data conveyed or communicated by the user. Should the input check data from the user not match with the stored proper check data, as a result of the comparison at block 78, the central computer 12 generates and sends a FAIL message to the user via the terminal 15 at block 80, such as to indicate that the check digit is incorrect.

When the user input and stored check data alternatively match as a result of the comparison at block 78, the central computer 12 sends a confirmation signal to terminal 15 (block 82).

In accordance with the present invention, the check data is selectively updated or varied. In one embodiment, after each successful pick, as indicated by a confirmed check digit 82, the check data might be changed. That is, the central computer 12 may subsequently or concurrently create new check data at block 84, which may be stored (block 86 for future use) or may be sent immediately to the display (block 88).

Various different embodiments of the invention ensure that the check data conveyed to the display 16 is selectively updated or varied. In one embodiment, the check data may be periodically varied. For example, the check data might be varied on an hourly, weekly, daily, monthly, or yearly basis. As such, the central computer 12 or other control unit may create and communicate new check data for a display 20 coincident with the end of each old period and the beginning of each new period. In an example where check data is varied on a weekly basis, a user on a Monday of a first week may be directed to pick particular quantities of certain shelved items. The user goes to the slots locations associated with an item and reads aloud into their headset 17 a first set of check data from a display 16 to vocally confirm the proper location and/or the proper picked items. For the duration of that first week, the check data for that display for the particular items will remain unchanged. That is, each time the user retrieves one of such items, they will be prompted to audibly speak the same set of check data presented on the display 16. On the following Monday, however, the central computer 12 will have varied the check data of the display 16. As such, when the user is tasked to confirm that they have retrieved the same item, the check data that the user reads will be new. In this manner, a user who attempts to confirm completion of the task by reciting check data memorized from the previous week will be unable to receive a confirmation signal. This feature thus ensures that the user actually goes to the proper location of the desired item and utilizes the full benefits of the inventory task management system or other system using the invention. The periodic variation of the check data may be accomplished manually by a supervisor or automatically by the central computer 12 at the proper periodic time table. While some items may allow longer periods before change is necessary, other items may be picked more often and thus are subject to abuse by workers in the area of check data verification. To that end, some of the displays of the invention might be updated or varied daily, while others weekly or even monthly. As may be appreciated, the invention provides numerous possibilities in periodic variation for all, some, or even a single display to ensure accuracy and efficiency in an inventory management, manufacturing, or other system.

In another embodiment, the central computer 12 or other control unit may automatically vary the check data in response to an event. For instance, the central computer 12 may communicate new check data to a display upon the completion of a successful pick by a user. In an example where check data is varied in response to a successful pick, a user speaks aloud into their headset 17 a first set of check data from a display 20 to vocally confirm the location and/or the items being picked. The central computer 12 receives and verifies this user input at steps 74 and 76 in FIG. 2. Should the input match at step 76, and the current check digit was spoken (step 78), the central computer 12 at step 84 will automatically vary the check data for the display associated with the picked item, store it for later verification 86, and then change the display 88. As such, when the user is subsequently tasked to retrieve an item from the same slot, the check data that the user reads will be different. In this manner, the user will be unable to memorize and retain check data from one pick to the next.

In another embodiment of varying check data in response to an event, the check data might be varied upon the completion of each scheduled shift. For example, a user's shift may begin at nine o'clock in the morning and end at five o'clock in the evening. The check data of a display 16 remains the same for the duration of the shift. That is, each time the user travels to a slot and reads the associated check data during the shift, it is the same. At five o'clock, however, the central computer 12 communicates new check data to the display 16. When the same or another user subsequently returns to the bin location and display 16, the display 16 includes new check data. Thus, the users will be unable to memorize and retain check data from one shift to the next. While such selective variation of the check data in response to an event is typically accomplished automatically by the central computer 12 or other control unit, it may alternatively be accomplished manually.

In still another embodiment of varying the display automatically upon the occurrence of an event, the event may be a replenishment of the items in a particular slot. In that way, fast moving items, which are often retrieved and thus present opportunities for memorization, have fast turnover in their check data. For example, when a slot is empty, a worker may need to replenish by placing another pallet of items in the slot. Frequently picked items require more frequent replenishment and, therefore, more frequent variation in the check data for the slot.

In another aspect, the check data may not only link the slot to particular check, digits, but may also link the pallet with the slot. For example, if a replenishment of slot 23 is made with pallet 456, the system will know the slot to verify and also the pallet that is being dealt with. As such, varying the check data according to the invention provides greater information with respect to an item being picked.

In another embodiment, the check data may be randomly varied. For example, a supervisor may randomly initiate a change in the check data. In such an instance, a facility manager may use their own discretion when deciding to enter a command into the central computer 12 or control unit that prompts the generation and communication of new check data to one or more displays. In one example, a supervisor may initiate such variation in response to learning that errors are increasing or the users are memorizing selected check data, indicating the potential that a user has undermined the verification process of the system by merely recalling check data, rather than reading it at the correct slot location. As such, at the discretion of the manager, the check data may be randomly varied. As noted above, individual slots or displays might be selectively varied in one embodiment of the invention. For example, while all displays must be on a periodic variation plan where they are varied on a regular basis, it may be desirable to randomly vary certain troublesome slots. The invention accommodates such a scenario.

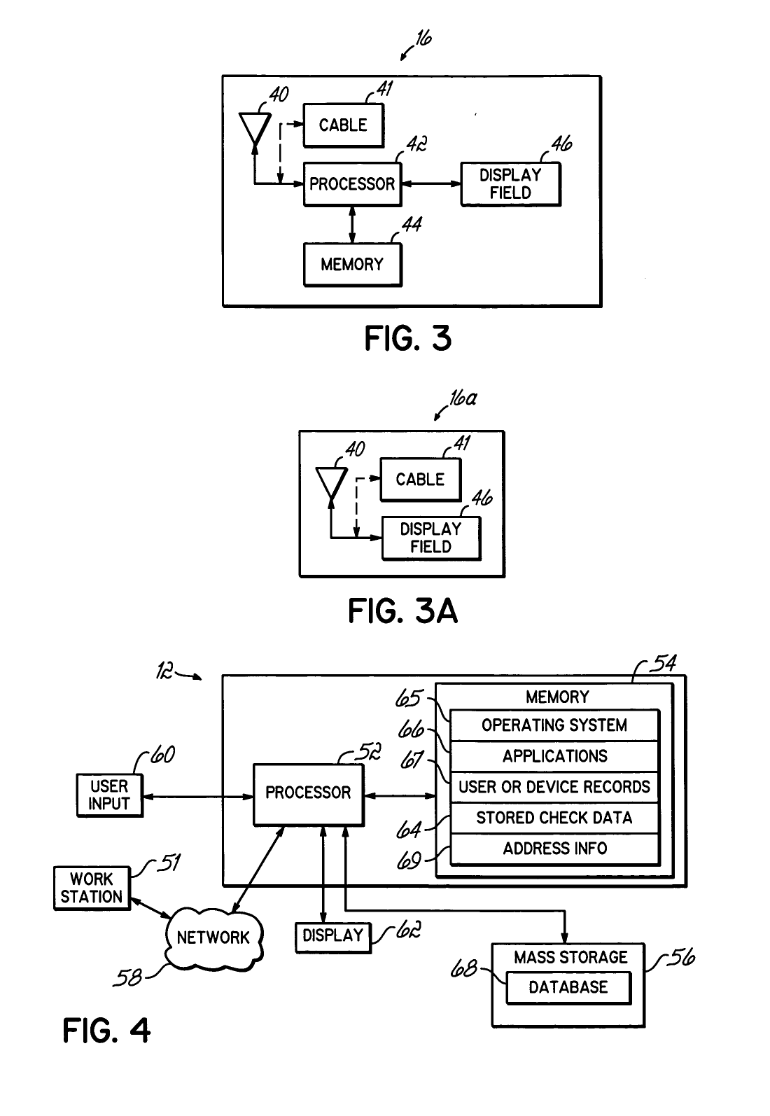

FIG. 3 is a block diagram of one suitable electronic display 16 of FIG. 1 for use in the invention. FIG. 3 more particularly shows an embodiment of a stand alone, remotely variable electronic display for use in communicating check data information and selectively varying that information in a manner that is consistent with the present invention. The display 16 uses appropriate electronic means for selectively displaying and varying the check data. For example, in one embodiment, the display 16 may include bistable, non-volatile imaging material, such as electronic ink disposed on a support. The bistable material may be set to one state and will remain in that state when the power is removed, as discussed below. The display 16 may also include an antenna 40 (for wireless application), hardwire cabling 41 or other interfacing communication device for communicating with the central computer 12 or control unit at least one of instructions, programs and data, including check data to be presented within an appropriate display field 46. The display 16 may be always on, or powered, or may alternatively be activated by a user or proximity trigger device worn by the user when the user has to read or otherwise perceive the data that is displayed.

In one embodiment, the electronic display 16 also includes a storage element, such as memory 44, operably coupled in circuit with the communication device 40. The storage element 44 is configured to store the instructions, programs and/or check data. The electronic display 16 may also include one or more control units, such as a processor 42, for configuring the check data to be displayed in accordance with the data signal from the central computer 12. The processor 42 may thus help control and coordinate operation of the display 16 based on instructions from a central computer or other control unit, and initiates any communications with the central computer 12 control unit. For instance, signals communicated by the display 16 may include status information indicative of the setting or power status of the display field 46. As described herein, communications from the central computer 12 to the electronic display 16 may be used by the processor 42 to address specific pixels or segments of the electronic display 16 to form the displayed check data.

In an alternative embodiment, as shown in FIG. 3A, the display 16a may not have or need a memory unit or processor unit. The display field 46 may be a standalone unit. A display field using an element with a bistable material is persistent and will maintain its state once changed or programmed without the need for a processor or memory or continuous power. The electronic display 16 is employed in connection with an object or location associated with a task and thus is generally collocated or positioned proximate the object or location. In one example, the electronic display 16 is specifically used in connection with a warehouse product slot, shelf, or bin, in the context of FIG. 1. The electronic display 16 may present check data as human or machine-readable indicia for verifying that the user is at the proper slot. As noted above, in other applications, display 16 might be utilized to actually display the slot number, as well as any check data.

The electronic display 16 may be temporarily or permanently affixed, coupled, secured or otherwise attached to a slot or bin according to known methods and techniques. According to one practice, a suitable conventional mechanical fastening system, such as fasteners, loop and hook type arrangements, stitches, adhesives and molding, as well as other known fixation techniques may be employed to attach the electronic display 16 to the slot/bin. The display 16 may also be integrally formed with the bin or other item, or may be used as a stand-alone display. Appropriate electrical or battery power is available at the display for its components.

As used herein, the term “display” may include a label, strip, tag, screen, or other general display device that is sufficiently sized and configured to present check data information or other related information either visually or optically. Moreover, while the display 16 of one embodiment consistent with the invention presents the check data visually, one skilled in the art will appreciate another display may alternatively or additionally audibly communicate check data, such as by using a speaker. Once the check data is perceived by the user or worker, it is conveyed to the central computer as appropriate for verification.

In one particular embodiment, the electronic display 16 may include electronic ink technologies for displaying the check data. The term electronic ink as used herein is intended to include any suitable bistable, non-volatile material. The term bistable as used herein is intended to indicate that the particles of the imaging material can alternately occupy two stable states. For example, the particles corresponding to different pixel locations of the display assembly can alternately occupy an ON or an OFF state to form selected indicia. The term non-volatile as used herein is intended to denote that the imaging material has indefinite memory without power and will retain an image in the absence of power to the electronic display. The particles in the imaging material maintain a first state unless actively directed to change to a second state. Thus, the imaging surface of the display shows a high quality image even when power to the display is turned off. This saves power and presents displays that are changed only when specific control signals are sent to them.

Various different display technologies under the general term “electronic ink” might be used to practice the invention. One type of electronic ink application may comprise a liquid crystal display having bistable and non-volatile indicia features. Another electronic ink application may include electronically reusable paper, i.e., a thin layer of transparent plastic in which millions of small beads, somewhat like toner particles, are randomly disbursed. The beads, each contained within a cavity, are free to rotate within those cavities. These gyricon beads are bichromal with hemispheres of two contrasting colors. The beads are further charged so they exhibit an electronic dipole. When voltage is applied to the surface of the display sheet, the beads rotate to present one colored side to the viewed. Voltages may be applied to the surface to create images that include text and pictures. The image will persist until new voltage patterns are applied.

The term electronic ink can also include a bistable, non-volatile cholesteric imaging material. The cholesteric liquid crystal material has positive dielectric anisotropy and can include a chiral material in an amount effective to form focal conic and twisted planar textures. Typically, cholesteric imaging material comprises liquid crystal cells range in thickness from about 25 microns to about 50 microns.

In addition, the electronic ink may include zenithal bistable display technology to form the bistable nonvolatile display assembly comprised of a bistable nematic liquid crystal device cell. The bistable nematic cell is provided with a surface alignment grating on at least one cell wall and a surface treatment on an opposite cell wall.

Further, the electronic ink may include a thermo-chromic material. A thermo-chromic material is capable of changing its state alternately between transparent and opaque upon the application of heat.

The electronic ink can also include surface stabilized ferroelectric liquid crystals. Surface stabilized ferroelectric liquid crystals confine ferroelectric liquid crystal material between closely-spaced glass plates to suppress the natural helix configuration of the crystals. The cells switch rapidly between two optically distinct, stable states simply by alternating the sign of an applied electric field.

Magnetic particles suspended in an emulsion may comprise an additional electronic ink imaging material suitable for use with the present invention. Application of a magnetic force varies pixels formed with the magnetic particles in order to create, update or change human and/or machine readable indicia.

Those skilled in the art will recognize that a variety of additional bistable and/or non-volatile imaging materials are available and may be implemented in the present invention. Moreover, while such bistable and non-volatile materials may present certain advantages in some scenarios, other embodiments consistent with the invention may be neither bistable nor non-volatile. For example, non-persistent elements such as static liquid crystal, light emitting diode, or other digital displays, may require persistent power sources coupled thereto to operate, such as power lines or batteries.

As noted above, it may be preferable to control all the displays with the central computer 12 or a control unit circuit block 21. Such control allows the displays to be integrated with an overall management software program, such as an inventory management program. FIG. 4 illustrates an exemplary hardware and software computer system 12, such as comprises the central computer, or tasking unit, shown in FIG. 1. The system 12 may include a management program that is configured to assign and manage tasks and to verify and update or vary check data using one or more displays 16, 20 in a manner consistent with the invention. For the purposes of this specification, the central computer 12 may represent practically any type of computer, computer system or other programmable electronic device, including a client computer, a server computer, a portable computer, a handheld computer, an embedded controller, etc. Moreover, the central computer 12 may be implemented using one or more networked computers, e.g., in a cluster or other distributed computing system.

Central computer 12 typically includes at least one processor 52 coupled to a memory 54. Processor 52 may represent one or more processors (e.g., microprocessors), and memory 54 may represent RAM, as well as any supplemental levels of memory, including memory storage physically located elsewhere in central computer 12, or in a mass storage device 56 or on another computer or device coupled to central computer 12 via the Internet or some other network 58.

For additional storage, central computer 12 may also include one or more mass storage devices 56, e.g., a hard disk drive. Furthermore, central computer 12 may include an interface with one or more networks 58 (e.g., a LAN, a WAN, a wireless network, and/or the Internet, among others) to permit the communication of information with other computers and devices coupled to the network. It should be appreciated that central computer 12 typically includes suitable analog and/or digital interfaces between processor 52 and each of components 54, 56, 58, 60 and 62 as is well known in the art.

Central computer 12 also typically receives a number of inputs and outputs for communicating information externally. For interface with a user or operator, central computer 12 typically includes one or more user input devices 60 (e.g., a keyboard, a mouse, a trackball, a joystick, a touchpad, and/or a microphone, among others) and a computer display 62. Alternatively, user input may be received via a workstation 51 used by remote personnel to access the central computer 12 via the network 58, or via a dedicated workstation interface or the like.

Central computer 12 typically operates under the control of an operating system 65, and executes or otherwise relies upon various computer software applications 66, programs and data structures, etc. (e.g., database 68, among others), or other computers 12 coupled in a distributed or client-server computing environment, whereby the processing required to implement the functions of a computer program may be allocated to multiple computers over the network.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature.

The central computer 12, or tasking unit, generally includes tasking software and circuitry to manage the assignment, coordination and completion of a multitude of worker tasks. The tasking unit may also be coupled to the displays 11, 16, 20 to control the selective variation of the check data to each display 11, 16, 20. For instance, the central computer 12 may keep track of check digits to ensure that there are no duplicates. The central computer 12 may also include verification software and circuitry comprising a verification unit. The verification unit is configured to verify the accuracy of the user-communicated check data. While such functionalities typically comprise program code stored within memory 54 of the central computer 12, one skilled in the art will appreciate that these tasking and verification features may alternatively be accomplished by separate units, e.g., a verification unit to verify check data, which need not necessarily be collocated with other units configured to accomplish specific features, such as tasking.

To aid in monitoring the devices 24, 26, the central computer 12 may maintain information 67 about which user is using what wireless device (e.g., terminal 15, 18), as well as address information 69 that associates a network address (e.g., an IP address) with a particular device, and, therefore with a particular user. Speech recognition software may be included within the central computer 12, or alternatively, within a terminal 15.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicants' general inventive concept.

What is claimed is:

1. A task management system comprising:
a tasking unit configured to communicate, to a user, a task associated with at least one of an object or a location;
an electronic display positioned proximate at least one of the object or the location, the electronic display configured to communicate and selectively vary check data that is reflective of the object or location associated with the task; and
a portable user input device configured to receive an input from the user reflective of the displayed check data.

2. The task management system of claim 1, wherein the check data displayed is varied periodically.

3. The task management system of claim 1, wherein the check data displayed is varied in response to an event.

4. The task management system of claim 3, wherein the event is a replenishment.

5. The task management system of claim 3, wherein the event is one of a successful pick and completion of a shift for the user.

6. The task management system of claim 1, wherein the check data displayed is varied automatically.

7. The task management system of claim 1, where the check data displayed is varied randomly.

8. The task management system of claim 1, wherein the check data displayed is varied at the direction of a person.

9. The task management system of claim 1, wherein the input is speech from the user.

10. The task management system of claim 1, wherein the electronic display includes an RFID tag and the input from the user is determined by an RFID reader.

11. The task management system of claim 1, wherein the portable user input device is configured to receive an audible input from the user.

12. The task management system of claim 1, further comprising a control unit coupled to the display to control the selective variation of the check data.

13. The task management system of claim 1, where the portable user input device sends the check data input to the tasking unit, the tasking unit operable to verify that the input is correct for the object or location associated with the task.

14. The task management system of claim 1, wherein the control unit is wirelessly coupled to the display.

15. The task management system of claim 1, wherein the portable user input device communicates wirelessly with the tasking unit.

16. The task management system of claim 1, wherein the portable user input device includes speech recognition software to recognize an audible input from the user.

17. The task management system of claim 1, wherein the check data is associated with a warehouse location, including one of a slot, bin, or aisle.

18. The task management system of claim 1, wherein the electronic display includes electronic ink material selected from a group consisting of: a bistable liquid crystal, gyricon, zenithal, thermochronic, ferroelectric liquid crystal and a cholesteric material.

19. The task management system of claim 1, wherein the control unit is collocated with the tasking unit.

20. The task management system of claim 1, wherein the electronic display includes a non-persistent element and a persistent power source coupled thereto.

21. A verification apparatus for verifying a task performed by a user, comprising an electronic display positioned proximate at least one of an object or location associated with the task, the electronic display operable to display and selectively vary check data associated with the object or location, so that a user may generate an input useful in verifying the task, but is prevented from memorizing the check data.

22. The apparatus of claim 21, wherein the check data is varied periodically.

23. The apparatus of claim 21, wherein the check data is varied in response to an event.

24. The apparatus of claim 21, wherein the check data is varied automatically.

25. The apparatus of claim 21 wherein the check data is varied randomly.

26. The apparatus of claim 21 wherein the displayed check data is varied at the direction of a person.

27. The apparatus of claim 23, wherein the apparatus is controlled by a control unit that assigns the task to the user.

28. A tasking assignment and verification system for directing workers to complete at least one task and to verify proper completion of the task comprising:
a central unit operable for assigning tasks to multiple workers and for directing the workers to go to various locations associated with the tasks;
verification units positioned proximate the various locations, each verification unit associated with a respective location or a product at the location and displaying verification data to be utilized by the worker to verify proper completion of the task;
the verification units operable to selectively vary the verification data to ensure physical proximity of the worker to the task location when verifying proper task completion.

29. The tasking assignment and verification system of claim 28, wherein the verification units are controlled by the central unit to selectively vary the verification data.

30. The tasking assignment and verification system of claim 28, the verification unit varying the verification data periodically.

31. The tasking assignment and verification system of claim 28, the verification unit varying the verification data at least one of automatically or randomly.

32. The tasking assignment and verification system of claim 28 further comprising a reporting unit configured to receive the verification data from the worker and report the received verification to the central unit.

33. The tasking assignment and verification system of claim 32 wherein the reporting unit is configured to receive human speech containing verification data.

34. The tasking assignment and verification system of claim 32 wherein the reporting unit is configured to receive electronic signals containing the verification data.

35. The tasking assignment and verification system of claim 32 wherein the reporting unit reports to the central unit wirelessly.

36. A method for managing tasks associated with at least one of a location and an object, the method comprising:
communicating to a user a task associated with at least one of the object and the location;
requiring the user to acquire check data from an electronic display positioned proximate at least one object or location to verify execution of the task; and
selectively varying the check data associated with the task.

37. The method of claim 36, wherein selectively varying the check data further comprises periodically varying the check data.

38. The method of claim 36, wherein selectively varying the check data further comprises varying the check data in response to an event.

39. The method of claim 38, wherein the event is a replenishment.

40. The method of claim 36 wherein selectively varying the check data further comprises randomly varying the check data.

41. The method of claim 36 wherein selectively varying the check data further comprises automatically varying the check data.

42. The method of claim 36, further comprising receiving an input from the user reflective of the check data.

43. The method of claim 42, wherein receiving the input from the user further comprises receiving speech from the user reflective of the check data.

44. The method of claim 42, wherein receiving the input from the user further comprises receiving an electrical signal reflective of the check data.
